(19) United States
(12) Patent Application Publication
(10) Pub. No.: US 2025/0174970 A1
(43) Pub. Date: May 29, 2025

(54) EXTERIOR MEMBER AND WIRE HARNESS

(71) Applicant: SUMITOMO WIRING SYSTEMS, LTD., Yokkaichi-shi (JP)

(72) Inventors: Takashi KAMBE, Yokkaichi-shi (JP); Hiroki UNO, Yokkaichi-shi (JP); Go UENO, Yokkaichi-shi (JP); Yuki MORIMOTO, Yokkaichi-shi (JP)

(73) Assignee: SUMITOMO WIRING SYSTEMS, LTD., Yokkaichi-shi (JP)

(21) Appl. No.: 18/962,418

(22) Filed: Nov. 27, 2024

(30) Foreign Application Priority Data
Nov. 29, 2023 (JP) 2023-201396

(51) Int. Cl. H02G 3/04; B60R 16/02

(52) U.S. Cl. CPC H02G 3/0468; B60R 16/0207

(57) ABSTRACT

An exterior member that includes: a tube that is configured for passing a wire therethrough, wherein the tube includes: a first bellows portion in which first ridge portions and first valley portions are alternately arranged in an axial direction of the tube; and a second bellows portion in which second ridge portions and second valley portions are alternately arranged in a peripheral direction of the tube, and the tube is made of an elastic material.

### BACKGROUND

The present disclosure relates to an exterior member and a wire harness.

JP 2017-220974A discloses a rubber boot with a bellows portion. The rubber boot is externally attached to an electric wire that connects the body and a sliding door in a vehicle.

### SUMMARY

When the rubber boot disclosed in JP 2017-220974A is externally attached to an electric wire, a connector and the electric wire extending from the connector are inserted into the rubber boot from a first end portion in the axial direction to a second end portion while the rubber boot is expanded so as to increase the size of the interior space. It is desired that the rubber boot can be expanded to a greater extent.

An exemplary aspect of the disclosure that provides technology capable of improving the expandability of an exterior member.

An exterior member of the present disclosure is an exterior member including a tube that is configured for passing a wire therethrough, wherein the tube includes: a first bellows portion in which first ridge portions and first valley portions are alternately arranged in an axial direction of the tube; and a second bellows portion in which second ridge portions and second valley portions are alternately arranged in a peripheral direction of the tube, and the tube is made of an elastic material.

With the present disclosure, it is possible to improve the expandability of an exterior member.

### BRIEF DESCRIPTION OF THE DRAWINGS

FIG. 1 is a perspective view showing an exterior member according to Embodiment 1.

FIG. 2 is a plan view showing the exterior member according to Embodiment 1.

FIG. 3 is a side view showing the exterior member according to Embodiment 1.

FIG. 4 is a cross-sectional view taken along line IV-IV in FIG. 2.

FIG. 5 is a cross-sectional view taken along line V-V in FIG. 2.

FIG. 6 is a cross-sectional view taken along line VI-VI in FIG. 2.

FIG. 7 is a perspective view showing a wire harness.

FIG. 8 is a perspective view showing the exterior member and a guide.

### DETAILED DESCRIPTION OF EMBODIMENTS

### Description of Embodiments of the Present Disclosure

First, aspects of the present disclosure will be listed and described.

Aspects of an exterior member of the present disclosure are as follows.

(1) An aspect of the exterior member of the present disclosure is an exterior member including a tube portion for passing a wiring member therethrough, wherein the tube portion includes: a first bellows portion in which first ridge portions and first valley portions are alternately arranged in an axial direction of the tube portion; and a second bellows portion in which second ridge portions and second valley portions are alternately arranged in a peripheral direction of the tube portion, and the tube portion is made of an elastic material.

In the exterior member of (1), the first bellows portion is provided for the purpose of easily bending the exterior member in the axial direction. The expandability of the exterior member is improved by providing the exterior member with the second bellows portion separately from the first bellows portion.

(2) The exterior member of (1) may have a configuration in which the tube portion includes a first tube portion having a quadrate transverse section, the first tube portion includes a pair of first wall portions, and a pair of second wall portions via which the pair of first wall portions are coupled, the pair of first wall portions are provided with the first bellows portion, and the pair of second wall portions are provided with the second bellows portion. With this configuration, the first bellows portion can be provided separate from the second bellows portion, and thus the second bellows portion is unlikely to inhibit the bending of the first tube portion at the first bellows portion.

(3) The exterior member of (2) may have a configuration in which the second bellows portion is provided at an intermediate portion in each of the pair of second wall portions, and the first bellows portion extends to an end portion of each of the pair of second wall portions located on an exterior side with respect to the second bellows portion. With this configuration, large creases are unlikely to be generated when the first tube portion bends at the first bellows portion.

(4) The exterior member of (3) may have a configuration in which end portions of the first valley portions join to the second valley portions. With this configuration, the expandability of the exterior member can be improved while an excessive decrease in the size of the interior space is suppressed.

(5) The exterior member of (4) may have a configuration in which end portions of the first ridge portions join to the second ridge portions. With this configuration, the expandability of the exterior member can be improved while the extrusion amounts of the second ridge portions on the outer surface of the exterior member are reduced.

(6) The exterior member of any one of (2) to (5) may have a configuration in which the tube portion includes a second tube portion provided with only the second bellows portion out of the first bellows portion and the second bellows portion. With this configuration, the expandability of the second tube portion, which is not required to bend in the axial direction, can also be improved due to the second bellows portion.

(7) The exterior member of (6) may have a configuration in which the second bellows portion is provided throughout the entire tube portion in an axial direction. With this configuration, the entire tube portion can be expanded in the axial direction using the second bellows portion.

(8) A wire harness of the present disclosure is a wire harness including: the exterior member according to any one of (1) to (7); a wiring member passed through the tube portion; and a connector provided at an end portion of the wiring member. With this wire harness, the size of the connector can be increased due to the improvement in the expandability of the exterior member.

### DETAILS OF EMBODIMENTS OF THE PRESENT DISCLOSURE

The following describes specific examples of an exterior member and a wire harness of the present disclosure with reference to the drawings. Note that the present disclosure is not limited to these examples and is defined by the scope of the appended claims, and all changes that come within the meaning and range of equivalency of the claims are intended to be embraced therein.

### Embodiment 1

Hereinafter, an exterior member and a wire harness according to Embodiment 1 will be described.

### Exterior Member

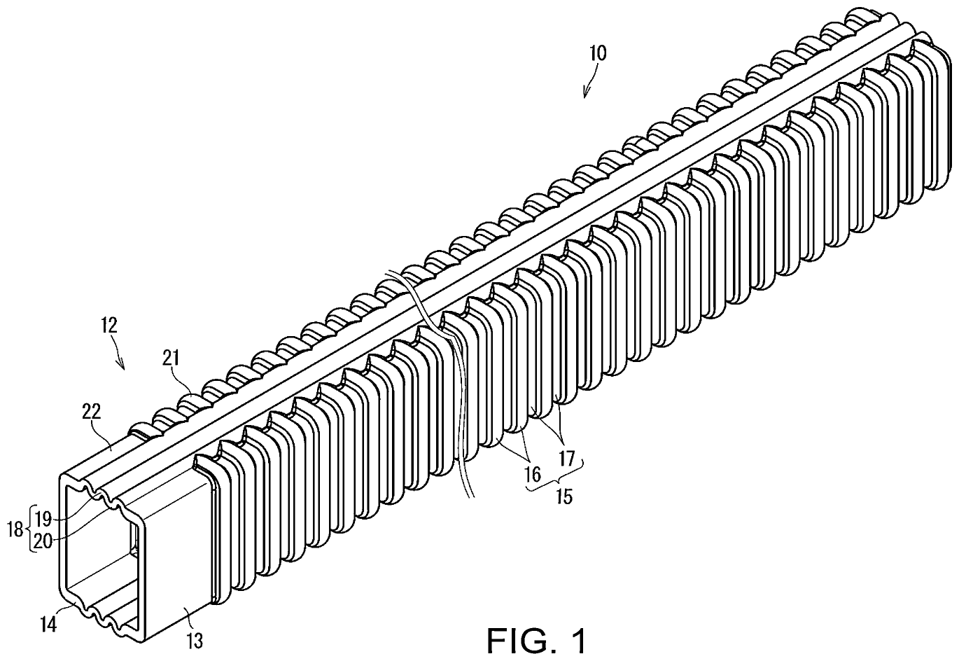

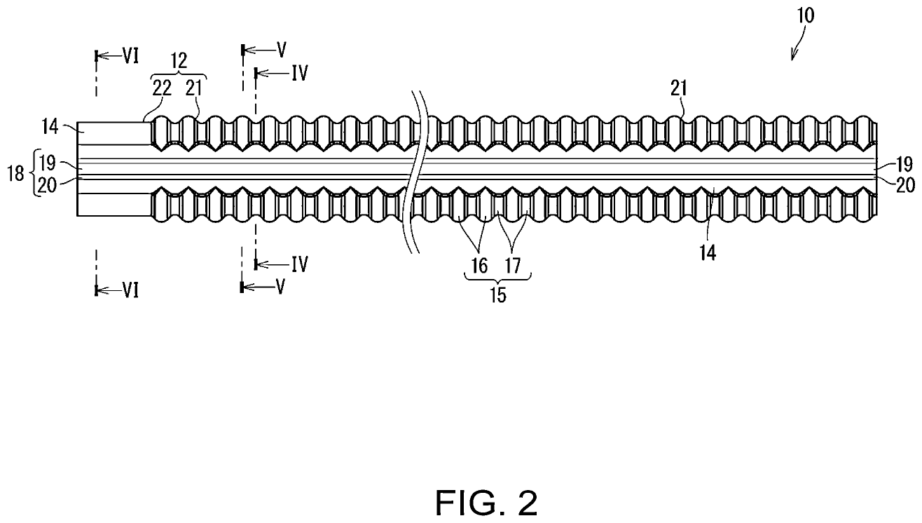

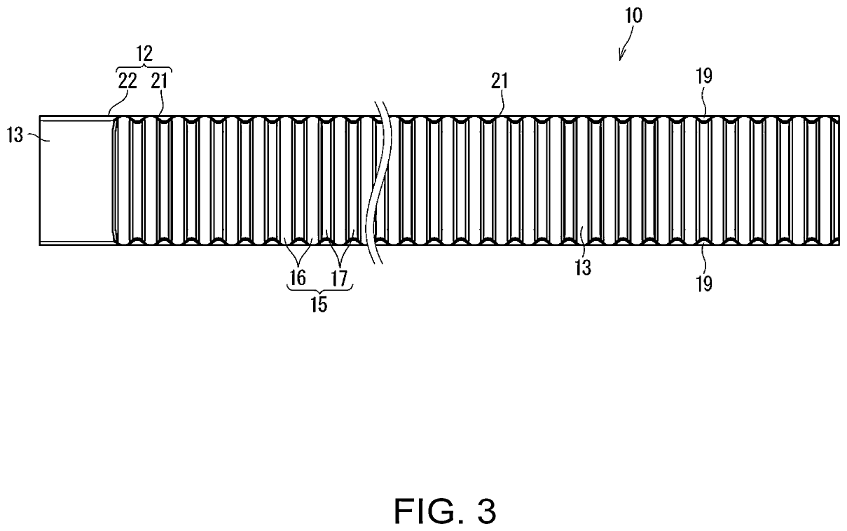

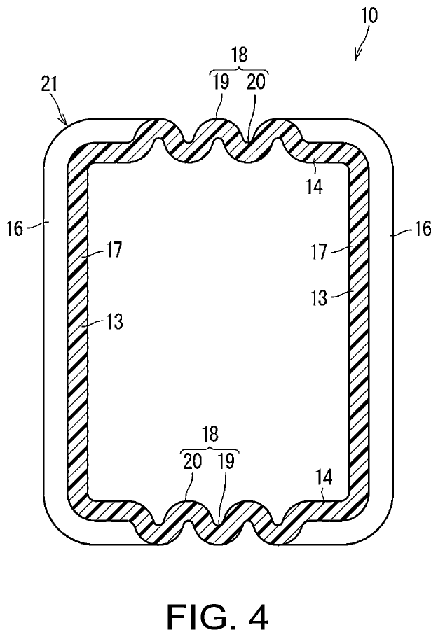

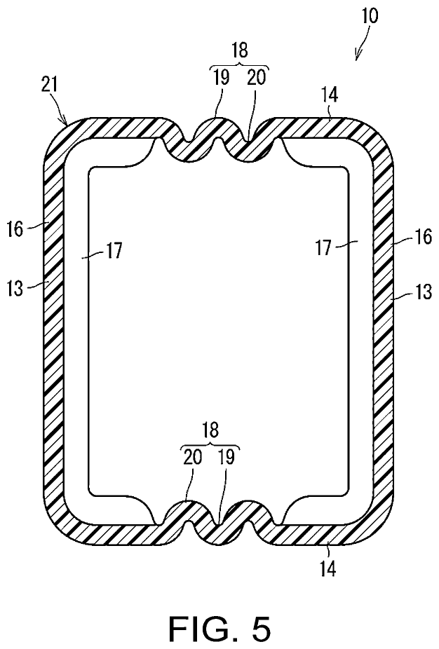

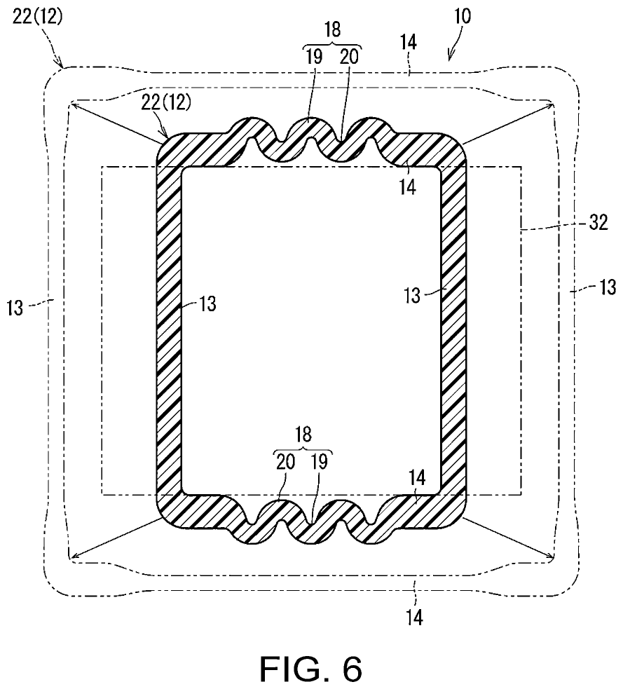

FIG. 1 is a perspective view showing an exterior member 10 according to Embodiment 1. FIG. 2 is a plan view showing the exterior member 10 according to Embodiment 1. FIG. 3 is a side view showing the exterior member 10 according to Embodiment 1. FIG. 4 is a cross-sectional view taken along line IV-IV in FIG. 2. FIG. 5 is a cross-sectional view taken along line V-V in FIG. 2. FIG. 6 is a cross-sectional view taken along line VI-VI in FIG. 2.

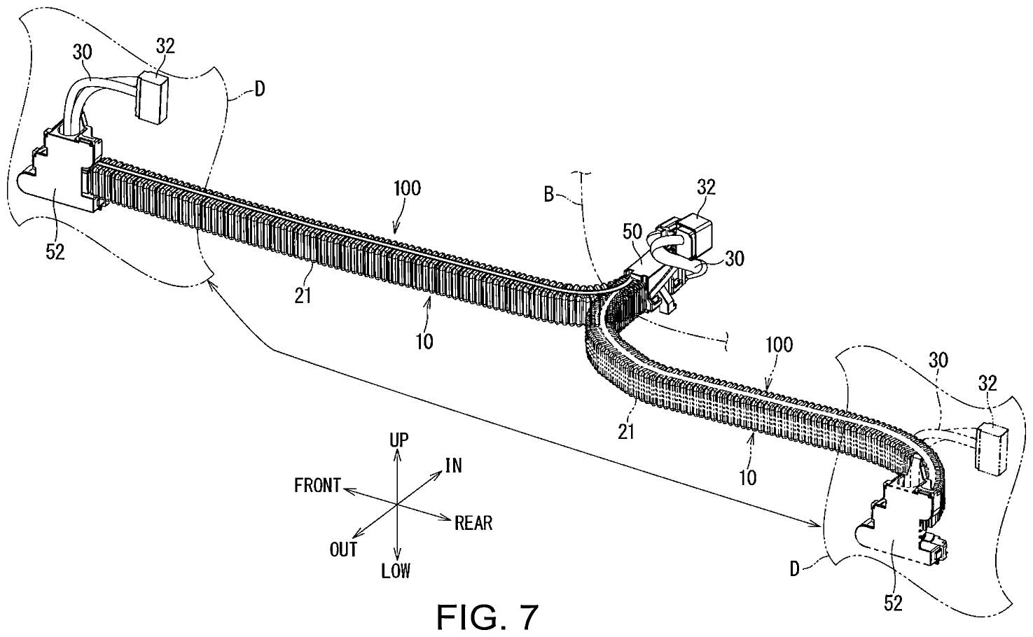

An exterior member 10 is externally attached to a wiring member 30 (see FIG. 7, which will be described later). The exterior member 10 includes a tube portion 12 (tube) for passing the wiring member 30 therethrough. The tube portion 12 is made of an elastic material.

The tube portion 12 includes a first bellows portion 15 and a second bellows portion 18. The first bellows portion 15 is a portion in which first ridge portions 16 and first valley portions 17 are alternately arranged in the axial direction of the tube portion 12. The second bellows portion 18 is a portion in which second ridge portions 19 and second valley portions 20 are alternately arranged in the peripheral direction of the tube portion 12. The first bellows portion 15 is shaped in a wave shape in the axial direction of the tube portion 12, and the second bellows portion 18 is shaped in a wave shape in the peripheral direction of the tube portion 12.

The tube portion 12 includes a first tube portion 21 and a second tube portion 22. The first tube portion 21 is a tubular portion provided with both the first bellows portion 15 and the second bellows portion 18. The second tube portion 22 is a tubular portion provided with only the second bellows portion 18 out of the first bellows portion 15 and the second bellows portion 18.

In the first tube portion 21, portions with the first ridge portions 16 may be considered as large-diameter tube portions and portions with the first valley portions 17 may be considered as small-diameter tube portions. The diameters of the large-diameter tube portions are larger than those of the small-diameter tube portions. Here, the inner diameters of the large-diameter tube portions are substantially the same as the outer diameters of the small-diameter tube portions. In the first tube portion 21, the small-diameter tube portions and the large-diameter tube portions are alternately and continuously arranged in the axial direction to shape the first bellows portion 15 into a bellows-like shape. The first tube portion 21 provided with the first bellows portion 15 is capable of undergoing stretching deformation in the length direction and bending deformation in the width direction.

The second tube portion 22 is not provided with the first bellows portion 15 for bending. Accordingly, the second tube portion 22 has difficulty undergoing stretching deformation in the length direction and bending deformation in the width direction compared with the first tube portion 21. The second tube portion 22 is a tubular portion elongated in the axial direction with a constant transverse sectional shape. The length of the second tube portion 22 in the axial direction is not particularly limited, but may be longer than, for example, that of one large-diameter tube portion or one small-diameter tube portion of the first tube portion 21.

Here, the tube portion 12 has a quadrate transverse section. The tube portion 12 includes a pair of first wall portions 13 (first walls) and a pair of second wall portions 14 (second walls). The pair of first wall portions 13 are coupled via the pair of second wall portions 14. In the vehicle mounted state, the pair of second wall portions 14 are arranged so as to be separate from each other in the vertical direction.

As shown in FIG. 4, the tube portion 12 may have a rectangular transverse sectional shape. Here, in the transverse section of the tube portion 12, the first wall portions 13 are longer than the second wall portions 14. In the rectangular transverse section of the tube portion 12, the first wall portions 13 form long sides, and the second wall portions 14 form short sides. The transverse section of the tube portion 12 may have a square shape, a circular shape, an oval shape, or the like.

The pair of first wall portions 13 in the first tube portion 21 are provided with the first bellows portion 15. The pair of second wall portions 14 in the first tube portion 21 and the pair of second wall portions 14 in the second tube portion 22 are provided with the second bellows portion 18. The second bellows portions 18 are provided at intermediate portions in the second wall portions 14 in the direction in which the pair of first wall portions 13 are coupled to each other (the left-right direction of the sheet of FIG. 4). Both of the end portions of each second wall portion 14 that are continuous with the first wall portions 13 are not provided with the second bellows portion 18.

In the first tube portion 21, the first bellows portions 15 extend to the end portions of the pair of second wall portions 14 located on the exterior side with respect to the second bellows portions 18. In the first tube portion 21, both of the end portions of each of the pair of second wall portions 14 that are continuous with the first wall portions 13 are provided with the first bellows portions 15. In the peripheral direction of the first tube portion 21, the end portions of the first bellows portions 15 join to the second bellows portions 18.

Here, the first ridge portions 16 and the second ridge portions 19 have the same height on the second wall portions 14. However, the first ridge portions 16 and the second ridge portions 19 may have different heights. Similarly, the first valley portions 17 and the second valley portions 20 have the same depth on the second wall portions 14. However, the first valley portions 17 and the second valley portions 20 may have different depths.

On the second wall portions 14, the end portions of the first valley portions 17 join to the second valley portions 20. The end portions of the first valley portions 17 on a first side join to the second valley portions 20 on the exterior sides on one of the pair of second wall portions 14. The end portions of the first valley portions 17 on a second side join to the second valley portions 20 on the exterior sides on the other of the pair of second wall portions 14. In the transverse section at the position of of the first valley portion 17 shown in FIG. 4, the second wall portions 14 are continuous with the first wall portions 13 at the positions of the second valley portions 20.

On the second wall portions 14, the end portions of the first ridge portions 16 join to the second ridge portions 19. The end portions of the first ridge portions 16 on a first side join to the second ridge portions 19 on the exterior sides on one of the pair of second wall portions 14. The end portions of the first ridge portions 16 on a second side join to the second ridge portions 19 on the exterior sides on the other of the pair of second wall portions 14. In the transverse section at the position of the first ridge portion 16 shown in FIG. 5, the second wall portions 14 are continuous with the first wall portions 13 at the positions of the second ridge portions 19.

The second bellows portions 18 are provided throughout the entire tube portion 12 in the axial direction. In the second bellows portions 18, the second ridge portions 19 and the second valley portions 20 continuously extend throughout the entire tube portion 12 in the axial direction. However, the second bellows portions 18 need not be provided throughout the entire tube portion 12 in the axial direction. The tube portion 12 may include a tube portion that is not provided with the second bellows portion 18.

As shown in FIG. 6, on each of the upper and lower second wall portions 14 in the second tube portion 22, the number of the second valley portions 20 is larger than the number of the second ridge portions 19. Here, each of the second wall portions 14 is provided with four second valley portions 20 and three second ridge portions 19. The second valley portions 20 are located on both the exterior sides of the second bellows portion 18 in the direction in which the pair of first wall portions 13 are coupled to each other (the left-right direction of the sheet of FIG. 6). Accordingly, the end portions of the second wall portion 14 at which the second bellows portion 18 is not provided extend toward the first wall portions 13 from the second valley portions 20. However, the number of the second ridge portions 19 and the number of the second valley portions 20 are not limited to the numbers above, and can be set as appropriate. For example, the number of the second ridge portions 19 may be larger than the number of the second valley portions 20, and in the second tube portion 22, the end portions of the second wall portion 14 at which the second bellows portion 18 is not provided may extend toward the first wall portions 13 from the second ridge portions 19.

In the transverse sectional shape of the small-diameter tube portion shown in FIG. 4, the arrangement of the second ridge portions 19 and the second valley portions 20 are the same as those in the transverse sectional shape of the second tube portion 22 shown in FIG. 6. In the transverse sectional shape of the large-diameter tube portion shown in FIG. 5, the end portions of the second wall portions 14 at which the second bellows portion 18 is not provided extend toward the first wall portions 13 from the second ridge portions 19. In the transverse sectional shape of the large-diameter tube portion shown in FIG. 5, the number of the second valley portions 20 is two less than the number of the second valley portions 20 in the transverse sectional shape of the second tube portion 22 shown in FIG. 6.

Here, the pitch of the first bellows portion 15 (the interval between the apexes of the two adjacent first ridge portions 16) is longer than the pitch of the second bellows portion 18 (the interval between the apexes of the two adjacent second ridge portions 19). However, the pitch of the first bellows portion 15 may be shorter than or equal to the pitch of the second bellows portion 18. The length of the second tube portion 22 in the axial direction may be about one to four times as long as the period of the first bellows portion 15.

The first tube portion 21 and the second tube portion 22 are provided at different positions in the axial direction of the tube portion 12. The first tube portion 21 makes up a portion in the axial direction of the tube portion 12, and the second tube portion 22 makes up the other portion. Here, the first tube portion 21 and the second tube portion 22 are adjacent to each other in the axial direction. The first tube portion 21 makes up a portion containing a first end portion of the tube portion 12, and the second tube portion 22 makes up a portion containing a second end portion of the tube portion 12. The first tube portion 21 makes up most of the tube portion 12. The tube portion 12 may have a configuration in which both ends are made up of the second tube portions 22, and a portion between the second tube portions 22 on both ends is made up of the first tube portion 21. The tube portion 12 may include only the first tube portion 21 without the second tube portion 22.

The exterior member 10 is, for example, an injection-molded article. The exterior member 10 may be, for example, an injection-molded article made of a single material. That is to say, the exterior member 10 may be made of only the elastic material used as the material of the tube portion 12. The exterior member 10 may include a portion molded using a material different from the elastic material used as the material of the tube portion 12, in addition to the tube portion 12.

The elastic material used as the material of the tube portion 12 is a flexible material such as a rubber or an elastomer. The elastic material may be, for example, an olefin-based thermoplastic elastomer (TPO), an ethylene-propylene rubber (EPDM), or the like.

The thicknesses of the wall portions of the tube portion 12 are not particularly limited, and can be set as appropriate. For example, the thicknesses of the wall portions of the tube portion 12 may be about 0.3 mm to 2 mm.

The length of the tube portion 12 is not particularly limited, and can be set as appropriate in accordance with the application, the length, and the like of the wiring member 30 passed therethrough. For example, when the wiring member 30 bridges a body B and a sliding door D of a vehicle as shown in FIG. 7, the tube portion 12 has a length that allows the sliding door D to be opened and closed.

### Wire Harness

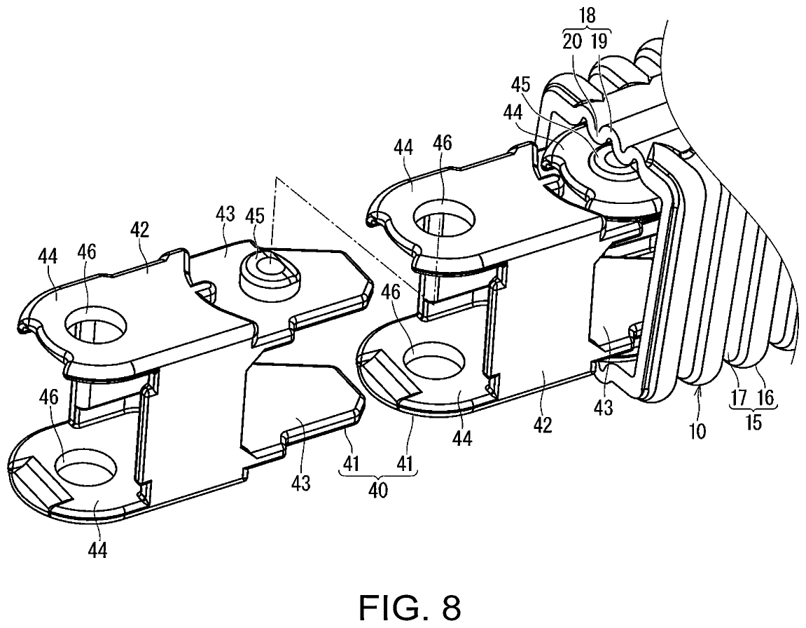

FIG. 7 is a perspective view showing a wire harness 100. In FIG. 7, a portion of the body B and a portion of the sliding door D are indicated by two-dot chain lines. In FIG. 7, the front-rear direction, the vertical direction and the vehicle interior-exterior direction are indicated. The sliding door D shown in FIG. 7 is located on the left lateral side of the vehicle, and is opened and closed by being moved in the front-rear direction. In FIG. 7, the form of the wire harness 100 when the sliding door D is closed is indicated by solid lines, whereas the form of the wire harness 100 when the sliding door D is open is indicated by two-dot chain lines. FIG. 8 is a perspective view showing the exterior member 10 and a guide 40. In FIG. 8, the exterior member 10 is cut away at an intermediate portion in the longitudinal direction in order to show the guide 40. Also, in FIG. 8, a portion of links 41 of the guide 40 is disassembled.

The wire harness 100 includes the exterior member 10, the wiring member 30, and connectors 32. The wiring member 30 is passed through the tube portion 12 of the exterior member 10. The wiring member 30 is a transmitting member for transmitting electric power or signals. The wiring member 30 is an electric wire, an optical fiber, or the like. One or more wiring members 30 are provided. The connectors 32 are provided at a first end portion and a second end portion of the wiring member 30.

Here, as shown in FIG. 7, the wire harness 100 bridges the body B and the sliding door D of an automobile. The wiring member 30 supplies electricity to a load or the like installed in the sliding door D or transmits signals between a load in the sliding door D and a load in the body B. The wire harness 100 further includes the guide 40, a body fixture 50, and a door fixture 52.

The guide 40 can undergo bending deformation in response to opening and closing of the sliding door D. The wiring member 30 is passed through the guide 40. The exterior member 10 is externally attached to the guide 40 and protects the wiring member 30 and the guide 40. The exterior member 10 and the wiring member 30 undergo deformation in response to the bending deformation of the guide 40. The guide 40 is located inside the first tube portion 21. The size of the guide 40 may be smaller than or equal to that of a space surrounded by the interior surface of the first tube portion 21. In this case, the guide 40 does not expand the exterior member 10 and the exterior member 10 does not press the guide 40. The guide 40 includes a plurality of links 41.

The links 41 are made of, for example, a synthetic resin. The links 41 have, for example, a tubular shape. The interior spaces of the links 41 are insertion spaces through which the wiring member 30 is inserted. As shown in FIG. 8, the plurality of links 41 are sequentially coupled in a row. The interior spaces of the adjacent links 41 are in communication. Also, the adjacent links 41 can be rotated relative to each other.

Each of the links 41 includes a main tube portion 42, two pairs of protruding plate portions 43 and 44, coupling protrusions 45, and coupling holes 46. The pair of protruding plate portions 43 protrude toward a first side from the main tube portion 42, and the pair of protruding plate portions 44 protrude toward a second side. The pair of protruding plate portions 43 are each provided with the coupling protrusion 45. The protruding plate portions 43 and the protruding plate portions 44 are not aligned in the thickness direction. For example, each of the coupling protrusions 45 protrudes, in the thickness direction, from the principal surface of the protruding plate portion 43 toward a side on which the corresponding protruding plate portion 44 is located. The pair of protruding plate portions 44 are each provided with the coupling hole 46. For example, the coupling hole 46 passes through the protruding plate portion 44 in the thickness direction. The protruding plate portions 43 of one link 41 of the two adjacent links 41 overlap the protruding plate portions 44 of the other link 41, and the coupling protrusions 45 of the one link 41 are fitted in the coupling holes 46 of the other link 41. Thus, the coupling protrusions 45 and the coupling holes 46 function as shaft portions and bearing portions, respectively, and the two adjacent links 41 are rotatably coupled.

The central axis of the coupling hole 46 serves as a rotation axis of the link 41. Here, the main tube portion 42 has a polygonal-tube shape, and the rotation axis extends in the long-side direction of the main tube portion 42. When the exterior member 10 is externally attached to the guide 40, the long-side direction of the first tube portion 21 extends along the long-side direction of the main tube portion 42. The exterior member 10 bends such that the short-side direction of the first tube portion 21 is a radial direction relative to the center of curvature.

The body attachment tool 50 fixes a first end portion of the wire harness 100 to the body B. The door fixture 52 fixes a second end portion of the wire harness 100 to the sliding door D. For example, the body fixture 50 supports a first end of the exterior member 10 and a first end of the guide 40. A first end of the wiring member 30 extends from the body fixture 50, and the connector 32 at the first end is connected to a counterpart connector provided on the body B. For example, the door fixture 52 supports a second end of the exterior member 10 and a second end of the guide 40. A second end of the wiring member 30 extends from the door fixture 52, and the connector 32 at the second end is connected to a counterpart connector provided on the sliding door D.

The tube portion 12 has an elongated tubular shape as a whole capable of surrounding the entire periphery of the guide 40 over the entire length of the guide 40. For example, the body fixture 50 and the door fixture 52 support the second tube portions 22. The guide 40 is passed through the exterior member 10 such that the rotation axis of the link 41 extends in a direction in which the pair of second wall portions 14 are linked. When bridging the body B and the sliding door D, the wire harness 100 is oriented such that the rotation axis of the guide 40 extends in the vertical direction. The bridging portion of the wire harness 100 between the body fixture 50 and the door fixture 52 serves as a free movement portion that moves in response to opening and closing of the sliding door D.

### Method for Producing Wire Harness

First, the end portions of the wiring member 30 are connected to the connectors 32, and the guide 40 is externally attached to the wiring member 30. In the following description, the wiring member 30 whose end portions are connected to the connectors 32 and to which the guide 40 is externally attached is referred to as a “wire harness main body”. Once the wire harness main body is completed, the wire harness main body is inserted through the exterior member 10.

Here, the exterior member 10 is provided with no slits extending in the axial direction, and thus cannot be split open. The exterior member 10 is expanded using a jig or the like so as to increase the size of the interior space. For example, the second tube portion 22 is expanded as indicated by virtual lines in FIG. 6. In this state, the wire harness main body is inserted through the exterior member 10 from the first end portion. The wire harness main body is inserted through the exterior member 10 until one of the two connectors 32 exits the exterior member 10 and the portion up to the other connector 32 is inserted into the exterior member 10, and thus the insertion of the wire harness main body through the exterior member 10 is finished. Then, the expanded state of the exterior member 10 is released, and the exterior member 10 returns to the state indicated by solid lines in FIG. 6.

The body fixture 50 and the door fixture 52 may be attached to the wire harness main body after the insertion of the wire harness main body through the exterior member 10 is finished. When the body fixture 50 and the door fixture 52 can be passed through the exterior member 10, they may be attached to the wire harness main body before the insertion of the wire harness main body through the exterior member 10 is finished.

When the insertion of the wire harness main body through the exterior member 10 and the attachment of the body fixture 50 and the door fixture 52 to the exterior member 10 are finished, the wire harness 100 is completed. While the wire harness 100 is disposed in a vehicle, the exterior member 10 is generally not expanded.

### Effects, etc.

With the exterior member 10 and the wire harness 100 configured as described above, the first bellows portion 15 is provided for the purpose of easily bending the exterior member 10 in the axial direction. The expandability of the exterior member 10 is improved by providing the exterior member 10 with the second bellows portion 18 separately from the first bellows portion 15.

The pair of first wall portions 13 are provided with the first bellows portion 15, and the pair of second wall portions 14 are provided with the second bellows portion 18. With this configuration, the first bellows portions 15 can be provided separate from the second bellows portions 18, and thus the second bellows portions 18 are unlikely to inhibit the bending of the first tube portion 21 at the first bellows portions 15.

The second bellows portions 18 are provided at intermediate portions in the pair of second wall portions 14, and the first bellows portions 15 extend to the end portions of the pair of second wall portions 14 located on the exterior side with respect to the second bellows portions 18. With this configuration, large creases are unlikely to be generated when the first tube portion 21 bends at the first bellows portions 15.

The end portions of the first valley portions 17 join to the second valley portions 20. With this configuration, the expandability of the exterior member 10 can be improved while an excessive decrease in the size of the interior space is suppressed.

The end portions of the first ridge portions 16 join to the second ridge portions 19. With this configuration, the expandability of the exterior member 10 can be improved while the extrusion amounts of the second ridge portions 19 on the outer surface of the exterior member 10 are reduced.

The tube portion 12 includes the second tube portion 22 provided with only the second bellows portion 18 out of the first bellows portion 15 and the second bellows portion 18. With this configuration, the expandability of the second tube portion 22, which is not required to bend in the axial direction, can also be improved due to the second bellows portions 18.

The second bellows portions 18 are provided throughout the entire tube portion 12 in the axial direction. With this configuration, the entire tube portion 12 can be expanded in the axial direction using the second bellows portions 18.

With the wire harness 100, the sizes of the connectors 32 can be increased due to the improvement in the expandability of the exterior member 10.

More specifically, the wiring member 30 with more circuits can be passed through the exterior member 10 due to the improvement in the expandability of the exterior member 10. For example, the connector 32 may be a member with the largest transverse sectional shape among members to be passed through the exterior member 10. The more circuits the wiring member 30 includes, the larger the size of the transverse sectional shape of the connector 32 is. A larger connector 32 can be passed through the exterior member 10 due to the improvement in the expandability of the exterior member 10. As shown in FIG. 6, the connector 32 may be, for example, larger than the unexpanded tube portion 12 and be capable of being passed through the tube portion 12 due to the tube portion 12 being expanded.

Furthermore, one type of exterior member 10 may be externally attached to wire harness main bodies that differ in the number of circuits. That is to say, exterior members 10 of the same size may be externally attached to a plurality types of wire harness main bodies having connectors 32 that differ in size. In this case, when the size of a connector 32 that can be passed through one type of exterior member 10 is increased, this one type of exterior member 10 can be applied to more types of wire harness main bodies that differ in the number of circuits.

### SUPPLEMENTARY NOTE

Note that the configurations described in the above-described embodiments and modified examples can be used in combination as appropriate as long as they are compatible with each other.

What is claimed is:

1. An exterior member comprising:
a tube that is configured for passing a wire therethrough, wherein:
the tube includes:
a first bellows portion in which first ridge portions and first valley portions are alternately arranged in an axial direction of the tube; and
a second bellows portion in which second ridge portions and second valley portions are alternately arranged in a peripheral direction of the tube, and
the tube is made of an elastic material.

2. The exterior member according to claim 1, wherein:
the tube includes a first tube portion having a quadrate transverse section,
the first tube portion includes a pair of first walls and a pair of second walls via which the pair of first walls are coupled,
the pair of first walls are provided with the first bellows portion, and
the pair of second walls are provided with the second bellows portion.

3. The exterior member according to claim 2, wherein:
the second bellows portion is provided at an intermediate portion in each of the pair of second walls, and
the first bellows portion extends to an end of each of the pair of second walls located on an exterior side with respect to the second bellows portion.

4. The exterior member according to claim 3,
wherein ends of the first valley portions join to the second valley portions.

5. The exterior member according to claim 4,
wherein ends of the first ridge portions join to the second ridge portions.

6. The exterior member according to claim 2,
wherein the tube includes a second tube portion provided with only the second bellows portion out of the first bellows portion and the second bellows portion.

7. The exterior member according to claim 6,
wherein the second bellows portion is provided throughout the entire tube in an axial direction.

8. A wire harness comprising:
the exterior member according to claim 1;
a wire passed through the tube; and
a connector provided at an end of the wire.
